(19) United States
(12) Patent Application Publication
(10) Pub. No.: US 2003/0093468 A1
(43) Pub. Date: May 15, 2003

(54) Method of providing XML web services on an embedded device

(76) Inventors: William Doyle Gordon, Vancouver (CA); Ming Huang, Burnaby (CA)

Correspondence Address: Geoffrey R. Myers, Esquire, Hall, Priddy, Myers & Vande Sande, 10220 River Road, Ste. 200, Potomac, MD, 20854, US

(21) Appl. No.: 10/083,297

(22) Filed: Feb. 27, 2002

(30) Foreign Application Priority Data
Oct. 19, 2001 (CA) 2,359,382

(51) Int. Cl. G06F 15/16

(52) U.S. Cl. 709/203; 709/230

(57) ABSTRACT

The invention consists of a method of providing XML web services on an embedded device. A web server is provided on the embedded device and a XML web services extension is installed on the web server. When the web server receives an HTTP request combined with a SOAP request from a web client, the web server forwards the SOAP request to the XML web services extension. The XML web services extension processes the SOAP request and produces a SOAP response. The SOAP response is combined with an HTTP response and returned by the web server to the web client.

The invention relates to a method of implementing a web server extension to provide XML web services on an embedded device.

### BACKGROUND

The Internet is largely composed of web servers providing HTML pages to viewers around the world. HTML is the language used for publishing hypertext on the World Wide Wed. It is a non-proprietary format that can be created and processed by a wide range of tools. HTML incorporates numerous extensions to support features such as graphics and streaming media. XML (and HTML) are usually transmitted using the Hypertext Transfer Protocol (HTTP). The advantages of using HTTP and XML as a mechanism for information exchange lies in the ability for systems using different operating systems to communicate with each other using these standards.

The majority of web servers include web server extensions. A web server extension is a mechanism that allows the functionality of the web server to be extended. One common use of web server extension mechanisms is to create a dynamic website, where that content is dynamically generated inside the code as opposed to using static HTML pages. The typical API for a web server extension is 1) initialize extension, 2) handle HTTP request, and 3) uninitialize extension.

XML web services is a term used to describe systems that use XML and HTTP to communicate in the same fashion as computers over the Internet. The NET platform from Microsoft represents one system of providing XML web services.

Three standards have arisen from Microsoft's NET. One is Simple Object Access Protocol (SOAP), which provides a way for a program running under one operating system (such as Windows 2000) to communicate with a program in the same operating system, or a different operating system (such as Linux) using HTTP and XML. SOAP specifies how to encode an HTTP header and an HTTP body containing XML content so one program can pass information to another program and receive a response from the second program.

The second standard is Universal Description, Discovery and Identification (UDDI). UDDI is an XML-based registry for businesses worldwide that is similar to a telephone directory. Using UDDI, businesses can locate one another and communicate using HTTP and XML without any additional information, reducing costs and time and streamlining transactions.

The third standard is Web Service Definition Language (WSDL). WSDL is used to provide a description of the XML web services available on a given device and how they may be accessed.

While the above standards are known and implemented on conventional desktop and laptop personal computers (PCs) and workstations, there is a rising demand for providing XML web services on smaller-scale devices. These devices are commonly referred to as embedded devices, and encompass a wide range, from Personal Digital Assistants (PDAs), to dedicated systems for controlled industrial machinery, to wall-mounted climate-control sensors.

In general terms, an embedded device is any specialized computer system that has a dedicated function. Typically, an embedded system is housed on a single microprocessor with the programs stored in Read-Only Memory (ROM). Most appliances that have a digital user interface, such as watches, microwaves, VCRs and automobiles, use embedded systems. Some examples of the diversity of embedded devices include Personal Digital Assistants (PDAs), dedicated systems that control industrial machinery, and wall-mounted climate-control sensors.

It is an object of this invention to provide a method of providing XML web services on embedded devices by using a web server extension. It is an additional object of this invention to provide a method of remotely configuring and controlling embedded devices using XML web services provided by a web server extension.

### SUMMARY

The invention consists of a method of providing XML web services on an embedded device. A web server is provided on the embedded device and a XML web services extension is installed on the web server. When the web server receives an HTTP request combined with a SOAP request from a web client, the web server forwards the SOAP request to the XML web services extension. The XML web services extension processes the SOAP request and produces a SOAP response. The SOAP response is combined with an HTTP response and returned by the web server to the web client.

Preferably, the XML web services extension utilizes a code template and a set of libraries for interpreting SOAP requests. The code template may be customized for the embedded device.

The SOAP request may contain remote management instructions for the embedded device. The XML web services extension may also be remotely configured by the web client.

The invention also includes a web server extension, comprised of a code template and a set of libraries, for providing XML web services on an embedded device. The code template may be customized for the embedded device.

The invention further includes a web server, comprised of a web server installed on an embedded device and a XML web services extension installed on the web server. The XML web services extension processes SOAP requests and the web server is capable of receiving HTTP requests combined with SOAP request and transmitting HTTP responses combined with SOAP responses.

### BRIEF DESCRIPTION OF THE DRAWINGS

The invention itself both as to organization and method of operation, as well as additional objects and advantages thereof, will become readily apparent from the following detailed description when read in connection with the accompanying drawings:

FIG. 1 is a diagram of conventional client-server communication using HTTP;

FIG. 2 is a diagram of client-server communication using HTTP and an XML web services extension; and

FIG. 3 is a flowchart showing how a SOAP request is handled by a XML web services extension.

### DETAILED DESCRIPTION

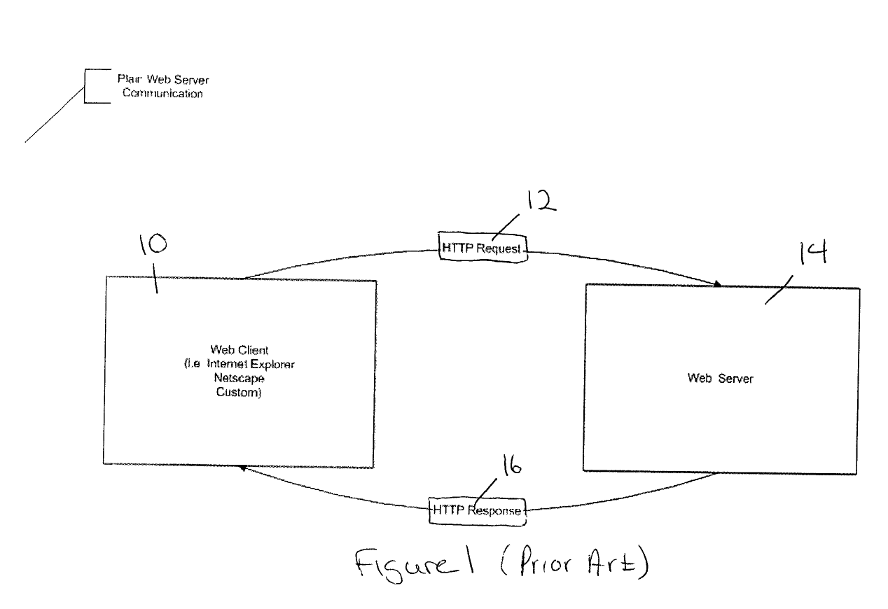

Conventional client-server communication using HTTP is shown in FIG. 1. A web client 10 sends an HTTP request 12 to the web server 14. The web server 14 processes the HTTP request 12 and formulates an HTTP response 16. The HTTP response 16 is then sent to the web client 10.

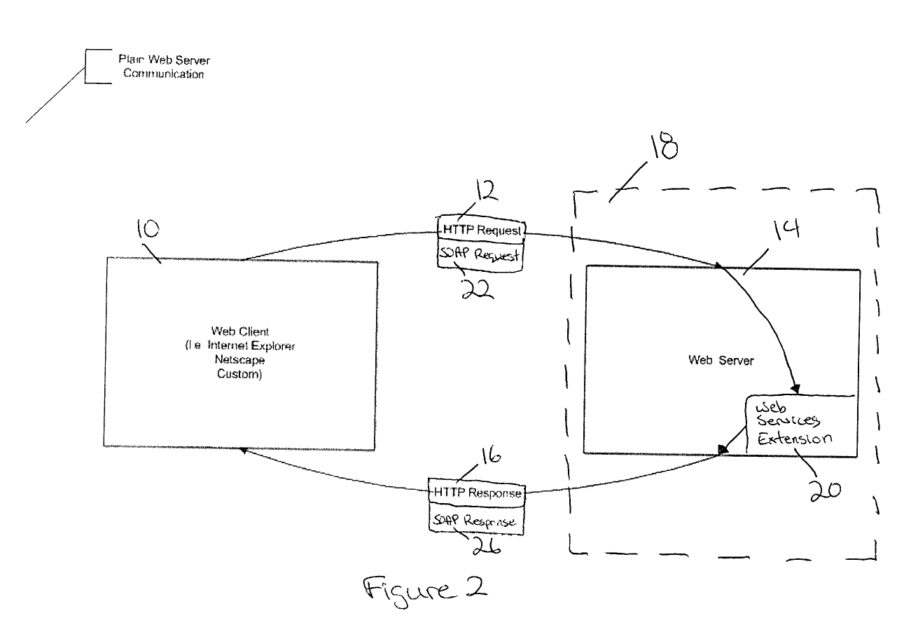

In FIG. 2, client-server communication using the Embedded XML web services (EWS) extension is shown. The web server 14 is now integrated into an embedded device 18. The web server 14 also includes the EWS extension 20.

The embedded device 18 can be any specialized computer system that has a dedicated functionality. Some examples of embedded devices include Personal Digital Assistants (PDAs), dedicated system for controlling industrial machinery, and wall-mounted climate-control sensors.

A web client 10 sends an HTTP request 12 to the web server 14. As part of the HTTP request 12, the web client 10 includes a SOAP request 22. When the HTTP request 12 is processed by web server 14, the SOAP request 22 is passed on to the EWS extension 20. The EWS extension 20 then processes the SOAP request 22 and formulates a SOAP response 26. The SOAP response 26 is attached to the HTTP response 16 and returned to the web client 10.

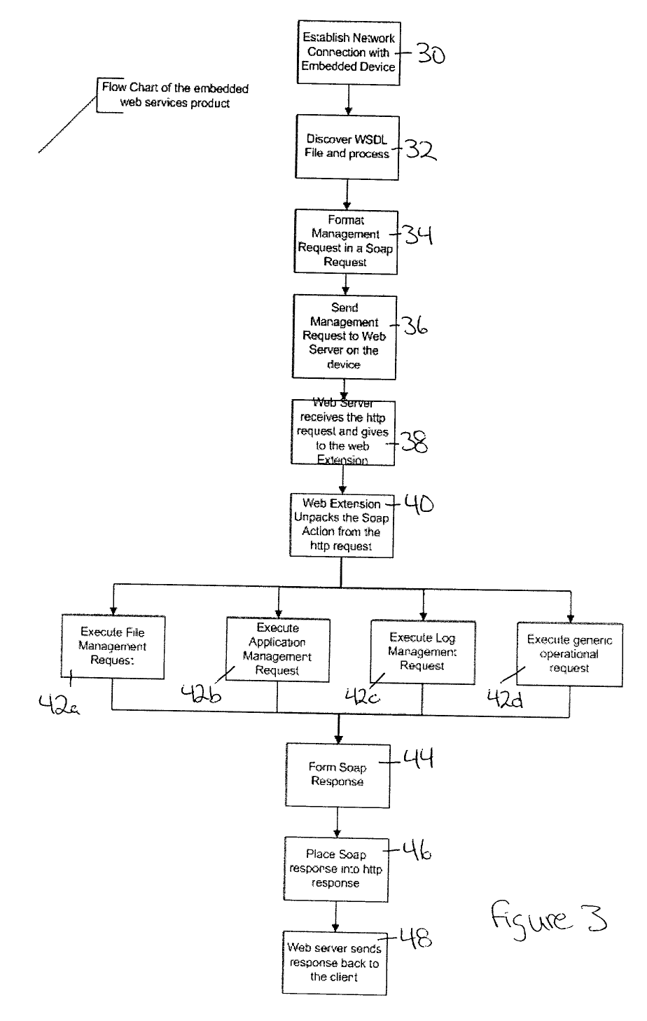

The process of handling the SOAP request is also shown by the flowchart in FIG. 3. The first step 30 is for the web client 10 to establish connection with the embedded device 18 using a discovery mechanism. This may be done using a variety of protocols and architectures, such as Universal Plug-and-Play (UPnP) on a Local Area Network (LAN), or through UDDI information or some other discovery mechanism. Once the web server has established a network connection, the WSDL file, which describes XML web services, is processed at step 32 to determine what XML web services are available on the embedded device, what methods are provided inside the XML web services and what defined interfaces can be invoked by the web client 10.

Some typical XML web services implemented on an embedded device include event log management (record entry, retrieve entry, clear log), file management (upload/download file, retrieve directory, copy file, delete file), application management (install/uninstall application), process managment (start/stop process) and registry management. Various customized management can also be developed and implemented as XML web services.

Once the XML web services are identified the web server waits for a SOAP request to process. The web client prepares a SOAP request at step 34 and sends it to the web server as part of an HTTP request at step 36. The web server receives the HTTP request and passes it to the EWS extension at step 38. The EWS extension unpacks the SOAP request from the HTTP request for processing at step 40.

Once unpacked, the SOAP request is processed by the EWS extension. The SOAP request can be any of the available XML web services, such as a file management request 42a, an application management request 42b, an event log management request 42c or any other generic operational request 42d. Once the request has been processed, a SOAP response is formed at step 44 by the EWS extension. The SOAP response is attached to the HTTP response at step 46 and the web server sends the combined HTTP and SOAP response back to the web client at step 48. Steps 34 to 48 are then repeated as necessary whenever a SOAP request is made by the web client.

The EWS extension 20 consists of two parts, a code template and a set of libraries. The code template provides the framework for the user to customize the EWS extension 20 for the specific purpose of the embedded device 18. The libraries are then accessed by the code template to handle the SOAP requests 22 from the web client 10.

A pseudo-code example of an EWS code template is shown below:

```
IF Web Server receives and verifies incoming HTTP request THEN DO
  Web Server loads relevant Web server extension module which
  represents a specific Embedded Web Service
ENDIF
IF Embedded Web Service module is loaded first time THEN DO
  Do standard initialization.
  Do user-defined initialization.
ENDIF
Embedded Web Service module process HTTP request including HTTP
header message and HTTP body message
IF Embedded Web Service module receives HTTP request first time
THEN DO
  Parse HTTP header
  Do service level standard initialization
  Do service level user-defined initialization
  Store self-explain data such as its own URL in global objects
  Create description document such as WSDL in global objects
ELSE DO
  Parse HTTP header
  Obtain HTTP Request verb from HTTP header
  IF HTTP verb == GET THEN DO
```

Verify HTTP header with optional query string to decide the
purpose
IF purpose is getting DISCO content THEN DO

Output DISCO content

ELSE IF purpose is getting WSDL content THEN DO

Output WSDL content

ELSE DO

Output User-defined default HTML page embedded with DISCO
information (optional)

ENDIF

ELSE IF HTTP verb == POST THEN DO

IF HTTP request is valid SOAP request THEN DO

Do User-defined SOAP procedure

IF SOAP request is a valid format THEN DO

IF SOAP request has been handled successfully THEN DO

Output User-defined SOAP response

ELSE DO

Output User-defined SOAP FAULT

ENDIF

ELSE DO

Output User-defined SOAP FAULT

ENDIF

ELSE DO

Do User-defined procedure (optional)
Output User-defined result (optional)

END IF

ELSE IF HTTP verb == other verb THEN DO

Do User-defined procedure (optional)
Output User-defined result (optional)

```
  ENDIF
ENDIF
IF Web Server is closing or is required to unload extension
modules THEN DO
  Web Server unloads Embedded Web Service module
ENDIF
IF Embedded Web Service module is unloaded THEN DO
  Do standard uninitialization
  Do user-defined uninitialization
ENDIF
```

By using the EWS extension on an existing web server, the memory requirements for XML web services handling are significantly reduced. Furthermore, by using a template and library system for handing SOAP requests, the EWS extension can be customized by the user for a given embedded device to ensure optimum performance and rapid development.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the scope of the invention.

We claim:

1. A method of providing XML web services on an embedded device, comprising:
(a) providing a web server on said embedded device; and
(b) installing a XML web services extension on said web server;
wherein, in response to said web server receiving an HTTP request combined with a Simple Object Access Protocol (SOAP) request from a web client, said SOAP request is forwarded by said web server to said XML web services extension where it is processed into a SOAP response and said SOAP response is combined with an HTTP response and returned by said web server to said web client.

2. The method according to claim 1, wherein said XML web services extension utilizes a code template and a set of libraries for interpreting SOAP requests.

3. The method according to claim 2, wherein said code template is customized for said embedded device.

4. The method according to claim 1, wherein said SOAP requests contain remote management instructions for said embedded device.

5. The method according to claim 1, wherein said XML web services extension can be remotely configured by said web client.

6. A method of using XML web services for communication between a web client and a web server, comprising:
(a) transmitting from said web client to said web server an HTTP request combined with a Simple Object Access Protocol (SOAP) request;
(b) receiving said HTTP request combined with said SOAP request on said web server, wherein said web server includes a XML web services extension and directing said SOAP request to said XML web services extension;
(c) processing said SOAP request in said XML web services extension and sending a SOAP response to said web server; and
(d) transmitting from said web server to said web client an HTTP response combined with the SOAP response;
wherein said web server is installed on an embedded device.

7. The method according to claim 6, wherein said XML web services extension utilizes a code template and a set of libraries for interpreting SOAP requests.

8. The method according to claim 7, wherein said code template is customized for said embedded device.

9. The method according to claim 6, wherein said SOAP request contains remote management instructions for said embedded device.

10. The method according to claim 6, wherein said XML web services extension can be remotely configured by said web client.

11. A web server extension for providing XML web services on a web server, comprising:
(a) a code template; and
(b) a set of libraries for interpreting SOAP requests;
wherein said web server is integrated into an embedded device.

12. The web server extension according to claim 11, wherein said web server extension receives SOAP requests from said web server and transmits SOAP responses to said web server and said web server receives HTTP requests combined with SOAP requests and transmits HTTP responses combined with SOAP responses.

13. The web server extension according to claim 11, wherein said code template is customized for said embedded device.

14. The web server extension according to claim 11, wherein said SOAP requests contain remote management instructions for said embedded device.

15. A web server, comprising:
(a) a web server installed on an embedded device; and
(b) a XML web services extension installed on said web server capable of processing Simple Object Access Protocol (SOAP) requests;
wherein said web server is capable of receiving HTTP requests combined with SOAP requests and transmitting HTTP responses combined with SOAP responses.

16. The web server according to claim 15, wherein said XML web services extension is comprised of a code template and a set of libraries for interpreting SOAP requests.

17. The web server according to claim 16, wherein said code template is customized for said embedded device.
